(19) United States
(12) Patent Application Publication
(10) Pub. No.: US 2018/0366024 A1
(43) Pub. Date: Dec. 20, 2018

(54) PROVIDING SUGGESTED BEHAVIOR MODIFICATIONS FOR A CORRELATION

(71) Applicant: Microsoft Technology Licensing, LLC, Redmond, WA (US)

(72) Inventors: Elad Yom-Tov, Hoshaya (IL); Hadas Bitran, Ramat HaSharon (IL); Shahar Yekutiel, Tel Aviv (IL); Gil Shacham, Ramat Hasharon (IL); Tachen Chester Ni, Bellevue, WA (US); Ryen W. White, Woodinville, WA (US)

(21) Appl. No.: 15/623,107

(22) Filed: Jun. 14, 2017

(51) Int. Cl. G09B 19/00; G06F 17/30

(52) U.S. Cl. CPC G09B 19/00; G06F 17/30595

(57) ABSTRACT

A method that includes accessing, from a database, a correlation between a first variable and a second variable; retrieving a list of suggested user behavior modifications for the correlation; selecting a user behavior modification from the list; presenting the selected user behavior modification to a computer device; receiving adherence data indicating a level of adherence by the user to the user behavior modification; and reevaluating the correlation between the first variable and the second variable based on the adherence data. The method may improve the determination of causality, versus merely correlation, between the variables. This determination may permit for improved recommendations to individuals to achieve a desired user outcome.

### TECHNICAL FIELD

Embodiments described herein generally relate to providing suggested behavior modifications for a correlation and in particular, but without limitation, to reevaluating a correlation based on adherence data relative to suggested behavior modifications.

### BACKGROUND

There are many cases where it is possible to identify correlations in people's behavior (e.g., between exercise and fitness level). However, it is hard to act on such correlations if the correlations cannot be shown to be causative. Understanding causation may be crucial to interpreting data collected from an individual and/or a population.

### SUMMARY

According to some implementations, a machine (e.g., a computing system) takes as input various variables (e.g., hours slept, miles run, calorie intake, etc.). The computing system establishes correlations between the variables and suggests behavior modifications based on the variables. As an example, the variables may demonstrate a correlation (e.g., a non-linear correlation) between cognitive function (i.e., attention) and the number of hours of sleep in the previous 24 hours.

Based on such a correlation, the computing system may generate decision rules that serve as a basis for suggesting behavior modifications. One example decision rule may be people who exercise sleep better at night. Another example decision rule may be people who do not drink coffee sleep better at night. Some known methods try to infer causality from historical data without intervention (i.e., requesting user action). This may be problematic in many situations because the inferred causal relationships are not tested to prove their causality and instead are only deduced.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example system in which variables may be collected and stored, in accordance with some embodiments.

FIG. 2 is a flow chart illustrating an example method for reevaluating a correlation based on adherence data relative to suggested behavior modifications, in accordance with some embodiments.

FIG. 3 is a diagram of an example Graphical User Interface (GUI) produced by a network-based communications application of a network-based communications service, in accordance with some embodiments.

FIG. 4 is a modified diagram of the example Graphical User Interface (GUI) shown in FIG. 3.

FIG. 5 is a flow chart illustrating example additional operations for the example method for reevaluating a correlation shown in FIG. 2.

FIG. 6 is a flow chart illustrating example additional operations for the example method for reevaluating a correlation shown in FIG. 2.

FIG. 7 is a block diagram illustrating components of a machine able to read instructions from a machine-readable medium and perform any of the methodologies discussed herein, in accordance with some embodiments.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

The implementations described herein relate to improving correlation analysis between variables using mini-experiments (e.g., suggested user behavior changes) to detect a change in correlation strength between the variables. The results of the analysis may improve the determination of causality, versus merely correlation, between the variables. This determination may permit for improved recommendations to individuals to achieve a desired user outcome.

The present disclosure describes, among other things, methods, systems, and computer program products that individually provide various functionality as it pertains to obtaining and using improved correlations. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

Some aspects of the subject technology are focused on collecting user data inputs from disparate data sources and synthesizing them into correlations. As used herein, variable may include two data points, a list of data points, a set of data points or an array of data points. In addition, variables may include data related to events, such as events, actions or occurrences recognized by a computing system (e.g., in the form of metadata) that are handled by the computing system.

The computing system may also receive data about other types of events from multiple different sources (e.g., online data repositories, a calendar associated with the user, inputs provided by use of a computer, etc.). The computing system then analyzes the variables (from a user or a population of users) to form correlations (e.g., bivariate correlations between two variables or multivariate correlations between three or more variables).

Accordingly, described herein in various implementations are technologies, including methods, machine readable mediums, and systems, that provide a suggested behavior modification to a user. The suggested behavior modifications could occur in various ways. One example way is utilizing explicit instruction to make suggestions. Another example way is implicitly suggesting (e.g., via content recommendations, advertising, etc.).

If more than one possible suggested behavior is appropriate, the suggestion may be selected from all of the possible suggestions taking into account the suggestion that (i) will most likely prove (or refute) the causative relationship; and/or (ii) is most likely to be adhered to by the user. Other factors may affect the selection of the suggestion.

Such suggestions can be reflected in the content being depicted to the user (e.g., content being shown within a web browser, media player, etc.). The user can retrieve and review content associated with the suggested behavior modifications.

Some aspects of the subject technology are focused on obtaining adherence data. The adherence data indicates a level of adherence by the user to the suggested user behavior modification.

As described herein, adherence data may have at least two properties. First, the adherence data may serve to help understand whether a suggested user behavior modification has worked and may lead to filtering certain suggestions to people that appear to be following the suggestions in order to achieve an outcome by modifying behavior.

Second, the adherence data may provide information on the modification itself. As an example, the adherence may serve to indicate whether a suggestion is even capable of being performed by a user and whether a user can stick to performing the suggested user behavior modification.

The example methods, systems, machine-readable media, and devices described herein reevaluate the correlations between variables. These revaluations may be based on the adherence data. The revaluations may be based upon current adherence data and may be associated personally with a user.

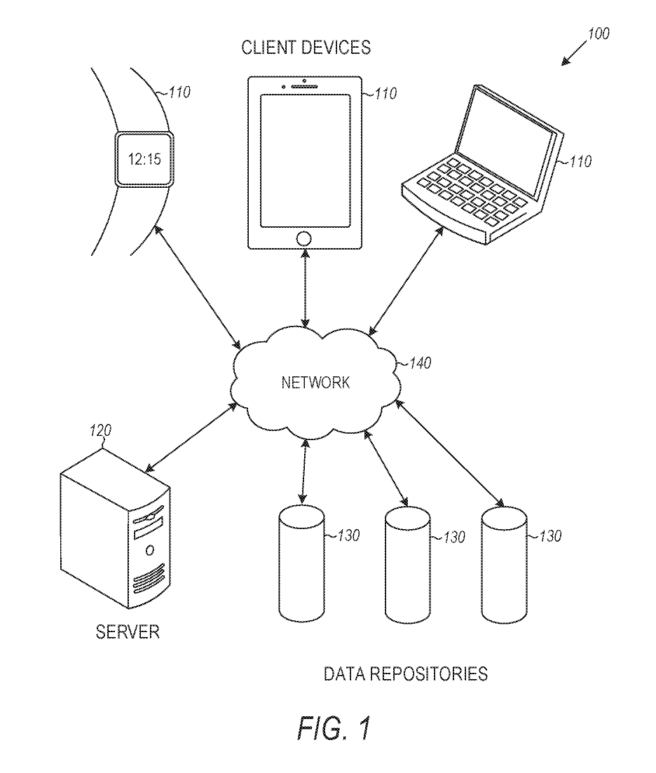

FIG. 1 illustrates an example system 100 in which data related to variables may be collected and stored, in accordance with some embodiments. As shown, the system 100 includes client devices 110, a server 120, and data repositories 130 connected to one another via a network 140. The network 140 may include one or more of the Internet, an intranet, a local area network, a wide area network, a wired network, a wireless network, a virtual private network (VPN), a cellular network, a Wi-Fi network, and the like.

As shown in FIG. 1, the client devices 110 include one or more of a sensing device (e.g. a fitness tracker), a mobile phone, and a desktop computer. The client devices 110 may include multiple such devices, as well as other devices that include a processor and a memory, such as a laptop computer, a tablet computer, a smart watch, teaching tools, vehicles, industrial machinery, medical devices, and the like. A set of client devices 110 may be associated with a user, for example, when the user connects (e.g., inputs identification information into a GUI) the client devices 110 to a user account.

The client devices 110 may include software or hardware for measuring health or exercise metrics, such as a heart rate, a skin temperature, a sleep metric, a distance traveled, a speed, a number of calories burned, and the like. The client devices 110 may include a network interface for transmitting the measured metrics via the network 140. Some client devices 110 also include a user input/output device, such as a touchscreen.

The data repositories 130 may include any databases or data storage units described herein. One or more of the data repositories 130 may store various correlations for various types of variables. The data repositories 130 may also store various variables and the corresponding correlations and decision rules based on the correlations for various types of variables. The data repositories 130 may be distinct from the client devices 110 and/or the server 120. In some embodiments, server 120 and data repositories are part of a shared cloud infrastructure service (e.g., MICROSOFT AZURE® or AMAZON EC2®).

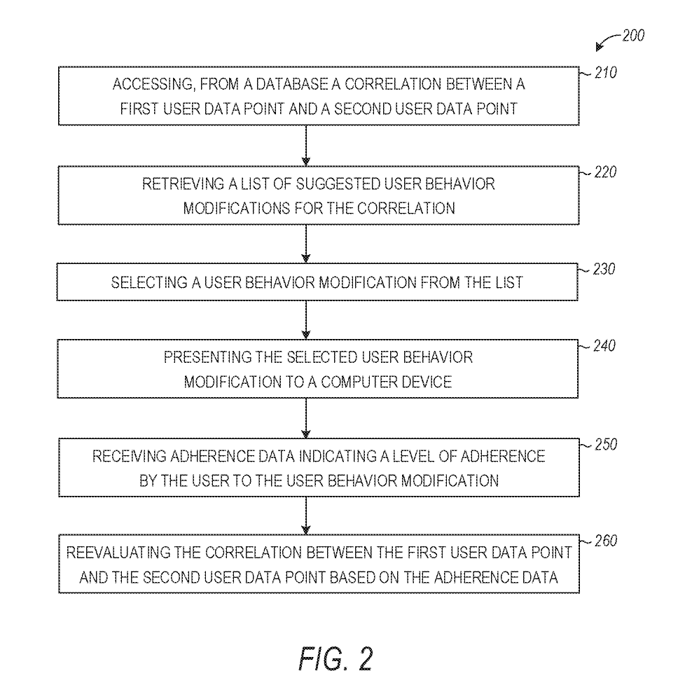

The server 120 may include a single server machine or multiple machines in a server farm. The server 120 includes one or more processors and a memory. The one or more processors are configured (e.g., via software stored in the memory or via the hardware of the one or more processors) to implement all or a portion of the methods described in conjunction with FIGS. 2, 5 and 6.

FIG. 2 is a flow chart illustrating an example method 200 for reevaluating correlations between at least two variables, in accordance with some embodiments. The method 200 may be implemented at a computing system, such as the client device 110 or the server 120.

At operation 210, the methods, systems, machine-readable media, and devices access from a database (e.g., data repositories 130), a correlation between a first variable and a second variable. In other forms, the computing system accesses from a database a correlation between multiple variables. Accessing the correlation may identify a type (e.g., biometric, typing speed) of the data points and the strength of the correlation strength between at least two variables. The correlations may be generated using any correlation technique, for example, regression (e.g., linear regression, power regression, logarithmic regression, exponential regression, etc.) or association rule mining (e.g., in the case of non-ordinal pairs).

The database(s) may include numerous correlations between a number of different types of variables. These correlations may be stored in the same database as the variables or stored in different databases.

In some instances, users may be randomized into mini-experiments so that they are independent when analyzing variables that form correlations and corresponding decision rules. Other forms are contemplated where the computing system directly collects data relating to variables in order to determine the causality of correlations by conducting mini-experiments.

In some aspects of the subject technology, the methods, systems, machine-readable media, and devices include an input/output component (e.g., a mobile phone, a tablet computer, a laptop computer, a desktop computer, a server, and the like) that receives variables. The variables may be received in the form of one or more events (e.g., running, typing, eating) and/or metadata about the events (e.g., metadata that indicates keystroke measurement, cursor movement, heart rate, distance run, time spent running, calories burned, and the like). The events and their metadata may be manually entered by the user or automatically received from a sensor or some other data collecting device (e.g., a fitness tracker).

As discussed in part above, the data may be obtained from a set of events (which may correspond to one or more variables), and possibly metadata related to the set of events. The set of events are generated by at least one client device 110, such as a sensor or any other client device. In one implementation, the metadata related to the set of events may include variables that are measured by a sensor (e.g., a fitness tracker). Examples of metadata include any measure of performance (e.g., human performances such as heart rate, skin temperature, sleep metric, distance traveled, speed, number of calories burned, and the like).

In some forms, the computing system forms the correlations based on the variables and stores the correlations in a database (e.g., on server 120 or in data repositories 130). In other forms, the computing system retrieves (and possibly stores) the correlations from another computing device (i.e., a separate database on another computing device).

In some implementations, the events may be generated (or triggered) by the computing system, a user of the computing system or in other ways. Example computer system types of events include, but are not limited to, a button being clicked, a mouse moving, text being entered into text fields, a programming closing, and the like.

In some forms, after a user completes an event, the user, a sensor monitoring the user or a computer being manipulated by the user uploads metadata about the event to the computing system (e.g., a fitness tracker, a mobile phone, a laptop, a remote online server machine, and the like). In other forms, the metadata about the event may be collected in real time.

The computing system may access events that indicate variables from multiple different sources. The computing system may access information about events (and the corresponding data points) of the user and of other similar users.

According to some examples, events are objects in the programming language Java or another programming language. They may come from a series of classes stored in java.util.EventObject (or another series of classes or different programming language structure).

In some forms, the variables may be provided with an indication of their correlation strength (for example in the form of a correlation coefficient as also referred to herein as a correlation value). The correlation values may be generated for individuals or populations from databases containing various types of variables.

If the correlation value falls below a given threshold, the correlation may be marked as non-causal in one direction (e.g., more sleep leads to more energy). In some cases, it may be possible to conduct a similar experiment to determine if the correlation is causative in an opposing direction (e.g., less sleep leads to less energy). In some forms, correlations which are evaluated to be below a threshold may be discarded.

As examples, the variables may include demographic and/or activity information. In some cases, if little information about the user is available, the data of other users is accessed. In some embodiments, only data about the user is accessed. As an example, other users may be identified based on the other users having similar demographics. For example, having an age within a threshold number of years (e.g., ten years) of the user, having a same gender as the specified user, or having a common geographic location (e.g., in the state of Connecticut) with the user.

At operation 220, methods, systems, machine-readable media, and devices retrieve a list of suggested user behavior modifications based on the correlation(s) according to some examples of the present disclosure. The list of suggested user behavior modifications may be generated because of a communication between users of a network-based communication service. The communication may have been received by the user from another user, or sent by the user to another user.

The communication may be submitted to different models that analyze the correlations and decision rules for variables. Each of the models that analyze the correlations may execute on one or more computing devices. The list of suggested user behavior modifications may that are received from the model(s) may be generated using a mapping between the communication and the correlations (e.g., based on a set of rules). If the computing device has limited display space (e.g., a mobile device), then a reduction function or limit may be applied to limit the number of suggestions.

The list of suggested user behavior modifications may comprise options for taking actions (and possibly provide additional content suggestions). The suggested user behavior modifications (e.g., run more, go to sleep earlier, eat more a particular type of food) may be based upon the events associated with the user, a population of users that are similar to the user, or an entire population of users.

Each user may therefore have their own different personalized list of suggested behavior modifications. The correlation values with respect to a particular user may be learned over time from interactions with the network-based communication service and other applications on one or more computing systems of the user.

The list of suggested behavior modifications may be generated based upon a number of different models that analyze the correlations. Each model may be specifically tailored to detect different types of correlations. The list of suggested user behavior modifications may be determined from the correlations and the corresponding decision rules that are formed from the correlations.

The suggested user behavior modifications may be ranked in order of the perceived strength (e.g., correlation coefficients closer to 1 or −1 are strongly than correlation coefficients of 0) of the correlation. Utilizing a number of different models to determine correlations may be more accurate than general models that attempt to discern general correlations.

In some forms, the list of suggested user behavior modifications may be ranked based upon previous interactions with previously delivered suggested behavior modifications. The ranking may utilize heuristics, a system-wide model, and a user-based model. The rankings may be based upon the type of suggestion and/or upon the suggestion itself. For example, the user may have previously shown (e.g., as set by the user as a preference, as detected in user activity, etc.) lots of interest in performing certain types of behaviors.

There are many ways in which correlations may be generated. In one simple example, if you have N input variables and M output variables, you could test N*M correlations and keep those with a significance score below a threshold (e.g., 0.05 with Bonferroni correction).

In other examples, a machine learning classification algorithm such as a multiclass logistic regression algorithm, a multiclass neural network, a multiclass decision forest, or the like may learn appropriate suggested user behavior modifications to be placed in the list of suggested user behavior modifications. The machine-learning algorithm may utilize training data in order to identify appropriate suggested user behavior modifications based upon the learned relationships between communications, correlations and suggested user behavior modifications.

At operation 230, the methods, systems, machine-readable media, and devices select a user behavior modification from the list of suggested user behavior modifications. In some forms, the list of suggested user behavior modifications may be ranked. As noted, the suggested user behavior modifications may be ranked based upon heuristic models, global system-wide models, and user-specific models. The models may be trained based upon feedback given to suggestions in the form of interacting (e.g., selecting) with the suggestions (or not interacting with the suggestions).

In some examples, the heuristic models may set up a priority ordering based upon the type of suggested user behavior modification. As an example, user behavior modifications that require a user to manually update adherence data may be ranked lower than user behavior modifications where the adherence data is automatically collected (e.g., by a sensor).

As an example, a fitness tracker (or some other form of sensor) may monitor the number of steps per day that is taken by the user. Since the variable (i.e., number of steps) is automatically collected, and therefore readily monitored, a suggested user behavior modification of “Increase your daily step count to 10,000” may be ranked more highly than a different suggested behavior that requires a user to manually enter information (e.g. daily caloric intake).

The global model and the user specific models may modify these rules based upon user interactions. In other examples, other machine learning models may be utilized such as logistic regression, linear regression, neural networks, decision trees, decision forests, and the like. These models may be initially trained using the heuristic model, then the model may be refined using first the global interaction data and then user specific interaction data.

By starting with a set of heuristics, the initial users of the system may experience a baseline ranking performance that is then trained by (i) the global user base; (ii) a user base that includes data from one or more groups similar users; and/or (iii) and the user's own preferences and selections. The use of both individual and system-wide computer interactions that are in the form of variables may provide a greater amount of training data to increase the model accuracy.

In addition, the variables may be selectively incorporated into one or models to improve accuracy. As an example, the suggested user behavior modification may be selected based on variables relating to demographic information of the user(s) in some (or all) of the models.

Depending on the amount of individualized interaction data that is obtained, this interaction data may be weighted more heavily in training the model to customize the rankings of the suggested user behavior modifications for the user. For example, the computing system may select the top ranked suggested user behavior modification in the list of suggested user behavior modifications.

The selection of the suggested user behavior modification from the list may be made by the user(s) of the computing system. Moreover, in certain implementations, the selection by can be made in various ways that permit the user to input the selection into the computing system.

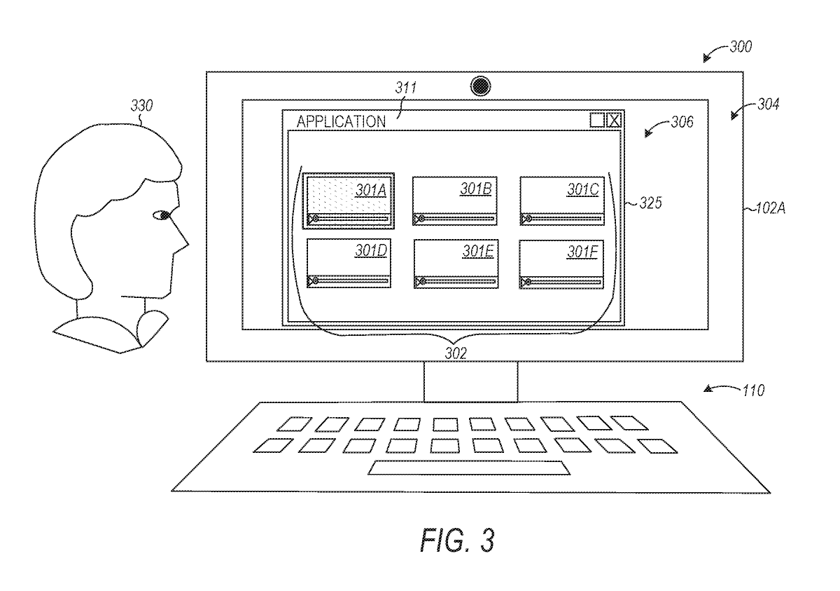

At operation 240, the methods, systems, machine-readable media, and devices present the selected user behavior modification to a computer device. Turning now also to FIG. 3, a diagram of a GUI 300 produced by a network-based communications application of a network-based communications service is shown according to some examples of the present disclosure.

As an example, the GUI 300 may be part of one or more of the client devices 110 of FIG. 1. The computing system presents the suggested user behavior modification using GUI elements in a personalized suggestion area 325.

Depending on the implementations of the methods, machine-readable mediums, and systems described herein, the selected suggested behavior modification 301A and/or the list 302 of suggested behavior modifications 301A, 301B, 301C, 301D, 301E, 301E may be displayed on the GUI 300. The computing system 100 may provide a report to the user of how the various variables influenced correlation strength and corresponding decision rules.

In some examples, the GUI elements containing the suggested may be buttons. In addition, the GUI elements containing the suggested behavior modifications 301A, 301B, 301C, 301D, 301E, 301F may be displayed in a given bounded area of the screen (e.g., personalized suggestion area 325) and the system may fit the personalized suggestion area 325 onto the GUI 300.

For example, as shown in FIG. 3, an array of icons representing suggested behavior modifications 301A, 301B, 301C, 301D, 301E, 301F is shown, with suggested behavior modification 301A potentially being distinguished from the other suggested behavior modifications 301B, 301C, 301D, 301E, 301F in some way (e.g., highlighting). Although depicted as icons, the suggested behavior modifications may include a textual description.

In some forms, the personalized suggestion(s) may be delivered through a personal digital assistant (e.g., such as CORTANA® from MICROSOFT®). For example, as shown in FIG. 3, GUI 300 may present user interface 306 to user 330 via display device 304. User interface 306 may be a graphical depiction of various applications executing on one or more of the client devices 110, such as application 311 (which can be, for example, a web browser or a media/video player).

Such application(s) can also include or otherwise reflect various content elements. Such content elements can be, for example, alphanumeric characters or strings, words, text, images, media (e.g., video), and/or any other such electronic or digital content that can be displayed, depicted, or otherwise presented via client device 110.

Various applications can also depict, reflect, or otherwise be associated with a content location. Content location can include or otherwise reflect a local and/or network/remote location where various content elements can be stored or located (e.g., a Uniform Resource Locator (URL), local or remote/network file location/path, etc.). Additional communications between the server 120 and/or data repositories 130 and the client device 110 may deliver additional information and content and assist the user in acting on the suggested behavior modifications 301A, 301B, 301C, 301D, 301E, 301F.

With reference back to FIG. 2, at operation 250, the methods, systems, machine-readable media, and devices receive adherence data indicating a level of adherence by the user to the user behavior modification. As an example, the adherence data may be represented as a graph illustrating metadata relating to a set(s) of events. The adherence data may be stored in a database, such as in database repository 130, as associated with a user and the user behavior modification.

As examples, the events may include one or more of a run event, a sleep event, a bike event, and a workout event. In some cases, compliance with a suggested behavior modification may performed by comparing suggested behavior modification 301A with obtained event metadata (e.g., to run a mile in 10 minutes) or a goal related to a number of events during a future time period (e.g., to work out twice in the next week and run three times in the next week).

In one example implementation, the set of events includes a run event and the output includes a graph of the distance (or time run) versus the suggested user behavior modification (running for a time and/or distance). In another example implementation, the set of events includes a sleep event and the output includes a graph of the number of hours slept in a day versus the suggested user behavior modification (e.g., sleeping for at least 8 hours in a day).

The server 120 may access metadata items from multiple different sources associated with a user. The multiple different sources may include client device(s) 110 associated with a user. Alternatively, the multiple different sources may include medical data obtained by a medical provider (e.g., a heart rate taken by a nurse during a visit to a physician's office) and stored in a data repository 130.

The server 120 determines that metadata items from two or more sources are related to an event performed by the user (e.g., a physiological activity, such as an exercise performance). The event may be any physiological activity, physiological occasion, or other physiological occurrence, for example, a run event, a sleep event, a bike event, or a workout event.

Further examples include a mobile phone application that may track how many times the user woke up during the night. During the night, the user may wear a heart rate tracker that tracks his/her heartrate. Based on the time of the heartrate measurements and the time of the sleep event from the mobile phone application, the server 120 may associate the heartrate measurements with the sleep event.

In some cases, the server 120 gathers from multiple different sources all the metadata that is associated with the event in order to gather as full a picture of the event as possible for making insights and conclusions. The metadata that is associated with the event may be identified based on the common metric or the contemporaneous time.

In one specific example, an event is a sleep event on a specified night. The metadata items include a heart rate from a wearable heart rate tracker, a sleep start time from a mobile phone, a sleep end time from the mobile phone, and a number of times woken up during the night from the mobile phone.

In some forms, the user may present the adherence data to one or more users in order to display adherence by the user. As an example, the adherence data may be presented to a GUI (e.g., GUI 300 in FIG. 3) that is also displaying the suggested user behavior modification and/or the list of suggested user behavior modifications.

At operation 260, the methods, systems, machine-readable media and devices reevaluate the correlation between the first variable and the second variable based on the adherence data.

The revaluations of the correlations may be generated based upon a number of different models that determine the reevaluations. Having a number of different models where each model is customized for revaluations may be more accurate than general models that try to discern all possible correlations.

As part of performing the reevaluation, a different set of models (or any of the previously referred to models) may produce a relevancy score based upon prior interactions by the user relative to the suggested behavior modification 301A. The list 302 of suggested user behavior modifications 301A, 301B, 301C, 301D, 301E, 301F may be re-ranked based upon a newly determined relevancy score (e.g., highest relevancy scores may be ranked highest in the list 302).

In some forms, each user may therefore have their own different personalized correlations as part of reevaluating the correlations. For example, the correlations of a particular user may be learned over time from variables relating to adherence data of the user that are obtained from the network-based communication service and other applications on one or more computing systems of the user.

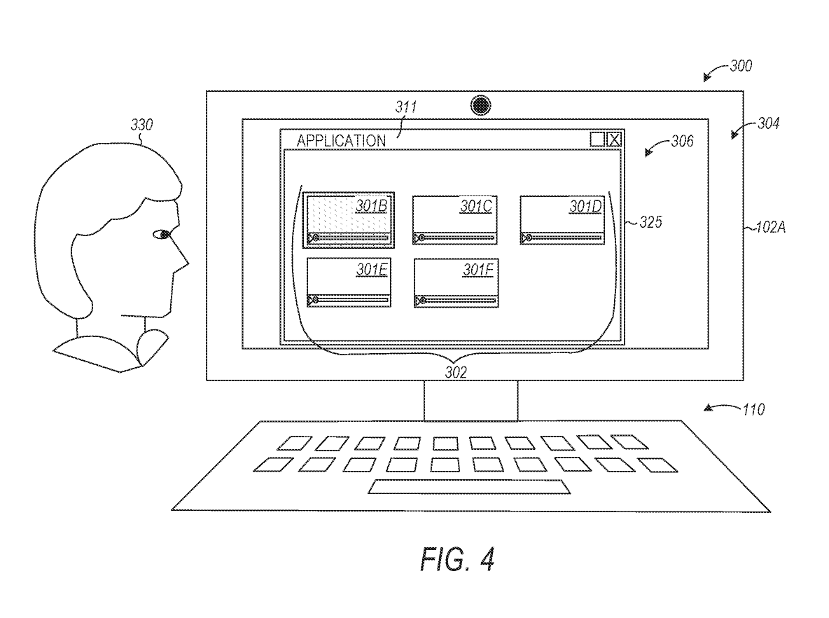

As shown in FIG. 4, the previously delivered suggested behavior modification 301A may also be re-ranked. As an example, a newly selected suggestion 302B (after revaluation) and/or the revised list 302 may be presented to the GUI 300 (as discussed above relative to FIGS. 1-3). The methods, systems, machine-readable media, and devices may enhance the display of the newly selected suggested behavior modification 301B (e.g., by highlighting), and/or the list 302 of suggested behavior modifications 301B, 301C, 301D, 301E, 301E on the GUI 300.

The re-ranked list 302 of suggested behavior modifications 301B, 301C, 301D, 301E, 301F may be kept active for a predetermined period. In some forms, once a predetermined period of time is over, the list 302 of suggested behavior modifications may be re-ranked again based on adherence data.

As an example, when additional adherence related metadata (e.g., from one client device such as a mobile phone) is provided to the server 120 the list 302 of suggested behavior modifications may be re-ranked again. When additional adherence related metadata is from another client device (e.g., the fitness tracker) is provided, the methods, systems, machine-readable media, and devices reevaluate the correlation(s) and decision rules based on the additional adherence data.

For example, if the event is a sleep event, and the metadata indicates that the user did not wake up at night and had a heartrate associated with deep sleep, the conclusion may be that the user slept well. If metadata indicates that the user weight-trained instead of doing cardio, the list 302 of suggested behavior modifications may be re-ranked. As part of reevaluating the correlation(s) and decision rules, the methods, systems, machine-readable media, and devices may be more likely to suggest that the user perform a certain user behavior modification (i.e. weight training).

In some forms, the server 120 and/or client devices 110 may present a strength of the correlation based on the reevaluating. The updated correlation may be used in calculating future lists 302 of suggested user behavior modifications. In addition, the new strength of the correlation may be provided to a client device 110 of the user (which may correspond to one device or multiple different devices).

In some forms, the GUI 300 of one or more client devices 110 may present the statistical significance of the correlation(s). The statistical significance may be presented on the GUI 300 in a variety of different forms. The statistical significance may allow one or more users to filter out spurious correlations that are part of the suggested behavior modifications.

The computing system 100 may provide a report to the user of how the various variables influenced correlation strength and corresponding decision rules. The statistical significance may be presented as alphanumeric characters or strings, words, text, images, media (e.g., video), and/or any other such electronic or digital content that can be displayed, depicted, or otherwise presented via client device 110. In addition, some of the suggested behavior modifications that have outlying statistical values may be distinguished from the other suggested behavior modifications in some way (e.g., highlighting).

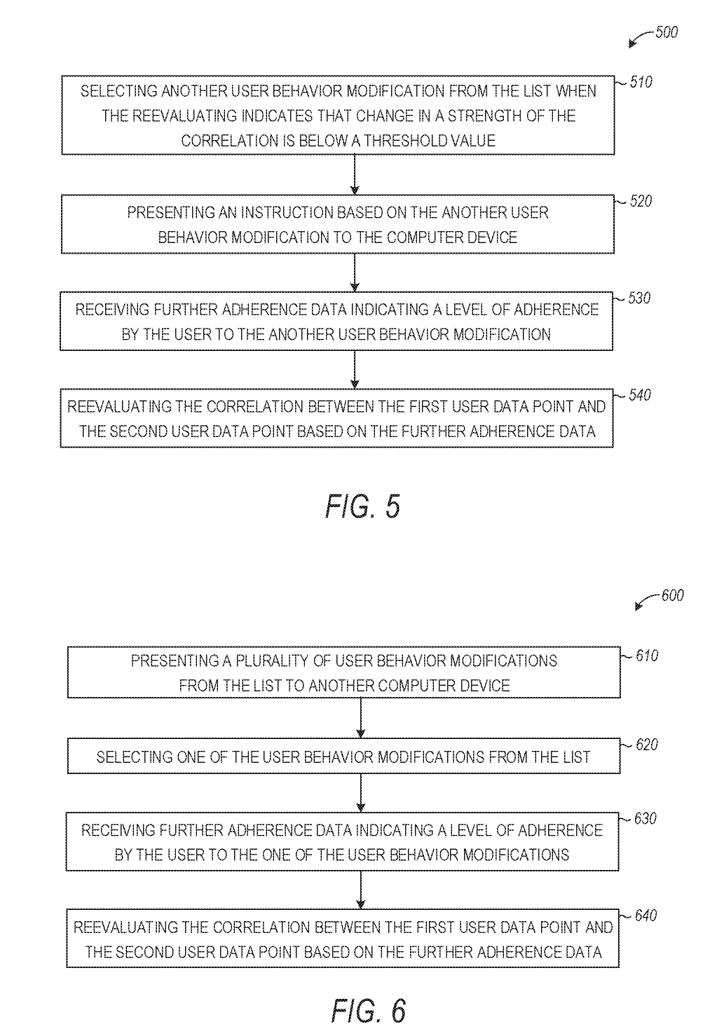

FIG. 5 is a flow chart illustrating possible future operations 500 for the method 200. The possible future operations of the method 200 may be implemented at a machine, such as the client device 110 or the server 120.

At operation 510, the methods, systems, machine-readable media, and devices select another user behavior modification from the list when the reevaluating at operation 260 indicates that a change in a strength of the correlation is below a threshold value.

As an example, if a suggested user behavior modification was to exercise 20 minutes a day in order to reduce blood pressure, and blood pressure was not reduced, then the strength of the correlation for blood pressure and exercise could be reduced. In some forms, the value may be brought below a threshold value so that the exercise 20 minutes a day user behavior modification is no longer suggested, and may possibly be removed from the list 302 of suggested behavior modifications.

In some implementations, when the strength of the correlation is below a threshold value another user behavior modification is selected where the strength of the correlation is above the threshold value. This updated selection (e.g., suggested user behavior modification 302B in FIG. 4) may be the current highest ranked user behavior modification in the list 302 of user behavior modifications. In some forms, correlations which are evaluated to be below a threshold may be discarded.

At operation 520, the methods, systems, machine-readable media, and devices present an instruction based on another user behavior modification to the computer device. Continuing with the just discussed example, the next suggestion on the list 302 of suggested behavior modifications (e.g. user behavior modification 302B) may display an instruction to the user to consume a diet of less than 2500 calories per day. As an example, the newly selected suggested user behavior modification 302B (after revaluation) and/or the revised list 302 may be presented to the GUI 300 (as discussed above relative to FIGS. 1-3).

At operation 530, the methods, systems, machine-readable media, and devices receive further adherence data indicating a level of adherence by the user to another user behavior modification (e.g., suggested user behavior modification 302B). With reference to the just described example, the metadata may be received from a client device 110, such as a sensor, and include variables relating to the amount of calories consumed per day and the user's blood pressure.

The metadata may be measured (e.g., by the fitness tracker) or manually entered by the user (e.g., into an interface within a mobile application or browser application presented at the client device 110). It should be noted that the further adherence variables might be received by any of the aforementioned methods described above.

At operation 540, the methods, systems, machine-readable media, and devices reevaluate the correlation between at least two variables based on the further adherence data. With reference to the just described example, the strength of the correlation between diet and blood pressure may be modified based on the based on the caloric input variables and blood pressure variables in the further adherence data.

The updated strength of the correlation may be provided in real-time upon receiving the metadata about the event of the specified user. The updated strength of the correlation may serve to identify the right user behavior modifications for optimizing (e.g., minimizing, maximizing, or placing within an identified optimal range) desired results. For example, the correlation (and corresponding decision rules that are generated from the correlations) may note that the user's average blood pressure typically enters an optimal “target blood pressure” range if the user consumes between 2000 and 2500 calories per day.

FIG. 6 is a flow chart illustrating possible future operations 600 for the method 200. At operation 610, the methods, systems, machine-readable media and devices present a plurality of user behavior modifications from the list to another computer device. As discussed above, the list 302 may be presented to the GUI 300 (as discussed above relative to FIGS. 1-4).

At operation 620, the methods, systems, machine-readable media and devices select one of the user behavior modifications from the list. As discussed above with regard to FIGS. 1-4, the suggestions in the list of suggested user behavior modifications may be ranked.

As noted above, the suggestions may be ranked based upon heuristic models, global system-wide models, and user-specific models. In some forms, the models may learn based upon feedback given to suggestions in the form of users interacting with the suggestions (or not interacting with the suggestions). As an example, a particular user behavior modification may be selected based upon the ranking in the list of suggested user behavior modifications.

At operation 630, the methods, systems, machine-readable media and devices receive further adherence data indicating a level of adherence by the user to the one of the user behavior modifications. In some forms, the adherence data may be represented as a graph illustrating the metadata of set(s) of events (and possibly external factor(s) correlated with the set of events).

As examples, the events may include one or more of a run event, a sleep event, a bike event, and a workout event. In some cases, compliance with a suggested behavior modification may performed by comparing suggested behavior modification with obtained event metadata or a goal related to a number of events during a future time period. In one example implementation, the output includes a graph of the collected metadata versus the suggested user behavior modification.

As discussed above, the server 120 may access metadata items from multiple different sources associated with a user. The multiple different sources may include client device(s) 110 associated with a user. Alternatively, the multiple different sources may include data from multiple sources and stored in a data repository 130.

At operation 640, the methods, systems, machine-readable media, and devices reevaluate the correlation between the first variable and the second variable based on the further adherence data. In some forms, the strength of the original correlation may be modified based on the variables in the further adherence data.

As discussed above, the updated strength of the correlation may serve to identify the right user behavior modifications for optimizing (e.g., minimizing, maximizing, or placing within an identified optimal range) desired results. For example, the correlation (and corresponding decision rules that are generated from the correlations) may note that the user-specific data for variables typically enter an optimal range if the user follows the suggested user behavior modification.

The methods, systems, machine-readable media and devices may receive the determined correlations and map them to suggestions. Returned correlations may include content as well as, or instead of, semantic meanings, such as text inputs via a keypad and the like. As examples, the mapping may be in the form of a table, or may be rule based, with if-then statements that are evaluated against the correlation values to determine the suggestion.

The methods, systems, machine-readable media and devices may also utilize profile data of the user. Profile data may be obtained based upon previous interactions by the user with the system 100. The profile data may be context specific, such that it stores preferences for varying contexts of the user (or similar groups of users). The suggestion ranking component may be performed using both user profile data and interaction history to rank the correlations relative to each other. Another factor that should be utilized when determining suggestion rankings is whether the suggestion is likely to prove or refute the causative relationship between variables.

As previously noted, the system may record interactions with the given suggestions and the system may use this feedback to learn how to better rank the correlations and corresponding suggestions. In some examples, this feedback may be shared with the system 100 to allow the system 100 to better learn the appropriate correlations and corresponding suggestions. Thus, a user's interaction with a particular suggestion provides both an indication as to how inferences and corresponding suggestions should be ranked, and provides an indication as to whether the system correctly identified the correlations of the relevant variables.

Lack of interaction with suggestions also indicates that those suggestions may be deprioritized and that the correlations were incorrect. In addition, the methods, systems, machine-readable media and devices may also monitor whether a user, or group of users saw the suggestion (e.g., by requiring that the user(s) take some action on the suggestion).

It should be noted that that there may be ordering effects that need to be considered by the systems described herein based on the sequence of suggested user behavior modifications, especially when the effects of each experiment are considered independently. In some forms, the system may factor in prior modifications into calculations in some way in order to increase confidence in a causal relationship and reduce confounding effects.

To protect user privacy, Graphical User Interfaces (GUIs) for user consent and opt-in or opt-out may be provided to allow users to assent to, or restrict, the collection of personal information. In some examples, these GUIs may allow users to delete previously collected information or set restrictions on the types and content of information collected.

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that a record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

Some aspects of the subject technology involve collecting personal information about users. It should be noted that the personal information about a user is collected after receiving affirmative consent from the users for the collection and storage of such information. Persistent reminders (e.g., email messages or information displays within an application) are provided to the user to notify the user that his/her information is being collected and stored. The persistent reminders may be provided whenever the user accesses an application or once every threshold time period (e.g., an email message every week). For instance, an arrow symbol may be displayed to the user on his/her mobile device to notify the user that his/her global positioning system (GPS) location is being tracked. Personal information is stored in a secure manner to ensure that no unauthorized access to the information takes place. For example, medical and health related information may be stored in a Health Insurance Portability and Accountability Act (HIPAA) compliant manner.

Example Machine and Software Architecture

The components, methods, applications, and so forth described in conjunction with FIGS. 1-6 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

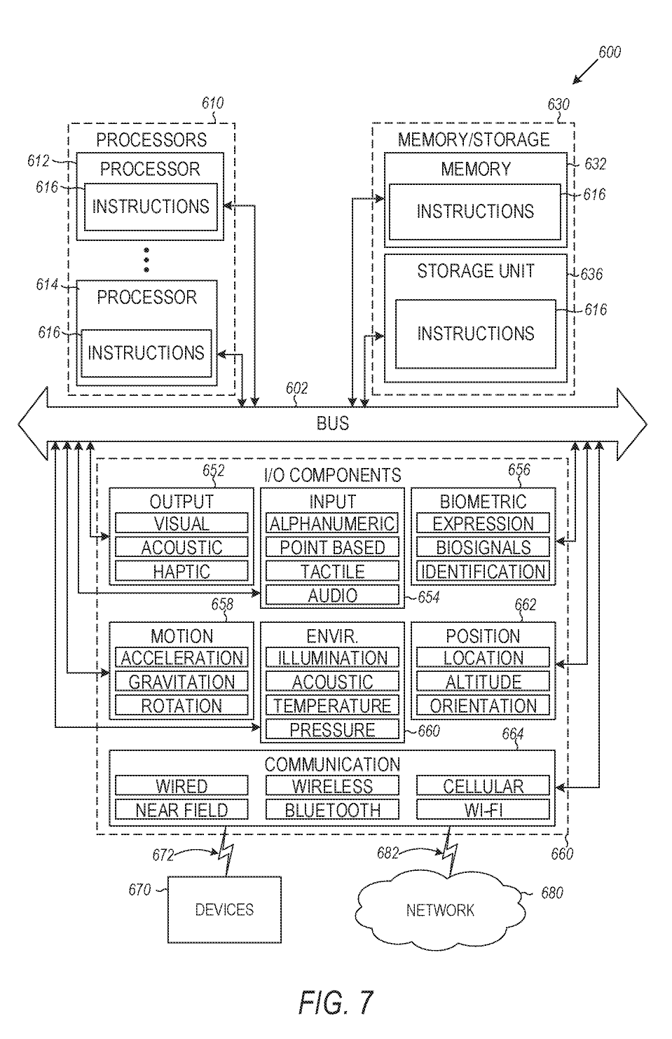

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. The instructions 716 transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions (e.g., instructions 716) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754.

The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth.

The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure bio signals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth.

The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment.

The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components, or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

In various example embodiments, one or more portions of the network 780 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

What is claimed is:

1. A method comprising:
accessing, from a database, a correlation between a first variable and a second variable;
retrieving a list of suggested user behavior modifications for the correlation;
selecting a user behavior modification from the list;
presenting the selected user behavior modification to a computer device;
receiving adherence data indicating a level of adherence by the user to the user behavior modification; and
reevaluating the correlation between the first variable and the second variable based on the adherence data.

2. The method of claim 1, further comprising:
presenting a strength of the correlation based on the reevaluating.

3. The method of claim 1, further comprising:
selecting another user behavior modification from the list when the reevaluating indicates that change in a strength of the correlation is below a threshold value;
presenting an instruction based on the another user behavior modification to the computer device;
receiving further adherence data indicating a level of adherence by the user to the another user behavior modification; and
reevaluating the correlation between the first variable and the second variable based on the further adherence data.

4. The method of claim 3, wherein selecting another user behavior modification from the list includes: selecting the another user behavior modification where the strength of the correlation is above the threshold value.

5. The method of claim 1, further comprising:
presenting a plurality of user behavior modifications from the list to another computer device;
selecting one of the user behavior modifications from the list;
receiving further adherence data indicating a level of adherence by the user to the one of the user behavior modifications; and
reevaluating the correlation between the first variable and the second variable based on the further adherence data.

6. The method of claim 1, further comprising: presenting adherence by the user to the selected user behavior modification to the computing device.

7. The method of claim 1, wherein receiving adherence data indicating a level of adherence by the user to the user behavior modification includes: receiving data from a wearable device.

8. The method of claim 1, wherein selecting the user behavior modification from the list includes: selecting the user behavior modification based on demographic information of the user.

9. A non-transitory computer readable medium comprising instructions, which when executed by at least one processor, configure the processor to perform operations comprising:
accessing, from a database a correlation between a first variable and a second variable;
retrieving a list of suggested user behavior modifications for the correlation;
selecting a user behavior modification from the list;
presenting the selected user behavior modification to a computer device;
receiving adherence data indicating a level of adherence by the user to the user behavior modification; and
reevaluating the correlation between the first variable and the second variable based on the adherence data.

10. The non-transitory computer readable medium of claim 9, the operations further comprising:
presenting a strength of the correlation based on the reevaluating.

11. The non-transitory computer readable medium of claim 9, the operations further comprising:
selecting another user behavior modification from the list when the reevaluating indicates that change in a strength of the correlation is below a threshold value;
presenting an instruction based on the another user behavior modification to the computer device;
receiving further adherence data indicating a level of adherence by the user to the another user behavior modification; and
reevaluating the correlation between the first variable and the second variable based on the further adherence data.

12. The non-transitory computer readable medium of claim 11, wherein selecting another user behavior modification from the list includes: selecting the another user behavior modification where the strength of the correlation is above the threshold value.

13. The non-transitory computer readable medium of claim 9, the operations further comprising:
presenting a plurality of user behavior modifications from the list to another computer device;
selecting one of the user behavior modifications from the list;
receiving further adherence data indicating a level of adherence by the user to the one of the user behavior modifications; and
reevaluating the correlation between the first variable and the second variable based on the further adherence data.

14. The non-transitory computer readable medium of claim 9, the operations further comprising: presenting adherence by the user to the selected user behavior modification to the computing device.

15. A system comprising:
at least one processor;
a storage device comprising instructions, which when executed by the at least one processor, configure the processor to perform operations comprising:
accessing, from a database a correlation between a first variable and a second variable;
retrieving a list of suggested user behavior modifications for the correlation;
selecting a user behavior modification from the list;
presenting the selected user behavior modification to a computer device;
receiving adherence data indicating a level of adherence by the user to the user behavior modification; and
reevaluating the correlation between the first variable and the second variable based on the adherence data.

16. The system of claim 16, the operations further comprising:
presenting a strength of the correlation based on the reevaluating.

17. The system of claim 16, the operations further comprising:
selecting another user behavior modification from the list when the reevaluating indicates that change in a strength of the correlation is below a threshold value;
presenting an instruction based on the another user behavior modification to the computer device;
receiving further adherence data indicating a level of adherence by the user to the another user behavior modification; and
reevaluating the correlation between the first variable and the second variable based on the further adherence data.

18. The system of claim 17, wherein selecting another user behavior modification from the list includes: selecting the another user behavior modification where the strength of the correlation is above the threshold value.

19. The system of claim 16, the operations further comprising:
presenting a plurality of user behavior modifications from the list to another computer device;
selecting one of the user behavior modifications from the list;
receiving further adherence data indicating a level of adherence by the user to the one of the user behavior modifications; and
reevaluating the correlation between the first variable and the second variable based on the further adherence data.

20. The system of claim 16, the operations further comprising: presenting adherence by the user to the selected user behavior modification to the computing device.
